(19) United States
(12) Patent Application Publication
(10) Pub. No.: US 2009/0142546 A1
(43) Pub. Date: Jun. 4, 2009

(54) SHEET SUPPORT FOR DIGITAL PHOTOGRAPH PRINTS

(75) Inventor: Emilio Tessera Chiesa, Rivoli (Torino) (IT)

Correspondence Address: HESLIN ROTHENBERG FARLEY & MESITI PC, 5 COLUMBIA CIRCLE, ALBANY, NY, 12203, US

(73) Assignee: SALES S.P.A., Rivoli (Torino) (IT)

(21) Appl. No.: 12/063,940

(22) PCT Filed: Aug. 14, 2006
(86) PCT No.: PCT/IB06/02259

§ 371 Date: Jul. 30, 2008

(30) Foreign Application Priority Data
Aug. 17, 2005 (IT) TO2005U000122

(51) Int. Cl. B32B 3/10

(52) U.S. Cl. 428/131

(57) ABSTRACT

A sheet support for digital photographic prints includes along at least one of its borders, perforations made at the origin for insertion of the sheet into a ringed file-holder or the like. The perforations are normally closed by a protective adhesive strip applied in a detachable way to the dorsal face of the sheet, possibly on a reinforcement film made of thermoplastic material provided in a position corresponding to the areas surrounding the perforations.

### BACKGROUND OF THE INVENTION

The present invention relates to a sheet support for digital photographic prints, comprising a substrate having a printing surface coating designed to receive ink pigments from a printer operatively associated to a computer or directly to a digital camera, i.e., from memory cards with printing function.

### STATE OF THE PRIOR ART

The techniques of digital photographic printing are by now widely used thanks to the possibility of enabling users of digital cameras to print their own photos without having to resort to specialized printing laboratories, using purposely designed and widespread processing programs interfaced with ink-jet printers, laser printers, dye-sublimation printers, or the like. In this way, the users can conveniently select the pictures to be printed, possibly touching them up and modifying the printing format thereof up to the maximum extension allowed by the sheets available on the market, typically A4 format.

Once they have been thus printed, the photos are usually arranged in order and filed in purposely designed photograph albums, which are normally relatively costly also on account of the need to provide adhesive corners for attaching the photographic prints to the pages of the album. This operation then requires precision, patience, and relatively long times, and a possible subsequent detachment of the photos from the album is far from easy.

It would hence be far more convenient and practical to be able to collect the digital photographic prints in normal and less costly ringed file-holders or the like, instead of in photograph albums. In this case, however, the user is forced to insert the printed sheets in purposely designed folders made of transparent plastic, usually employed for filing documents and provided with side holes for insertion of the rings of the file-holder. This in any case involves, in addition to the cost for the folders, operations that are long and troublesome, with the added risk of the prints accidentally falling out of the folders during manipulation of the file-holder, above all if the format of the print is smaller than that of the folder.

An alternative for the user could consist in perforating the sheets along the side after having printed them to enable direct insertion in the holes of the rings of the file-holder. It is, however, evident that also the perforation would require, in addition to the use of a purposely designed perforating implement, considerable precision and patience.

### SUMMARY OF THE INVENTION

The purpose of the present invention is to provide a simple, practical and functional solution to the aforesaid drawbacks, and said purpose is achieved thanks to a sheet support for digital photographic prints of the type defined at the start, the innovative and peculiar characteristic of which lies in the fact that, along at least one of its borders, it has perforations made at the origin for insertion of the sheet in a ringed file-holder or the like, and in that said perforations are normally closed and are also re-openable, following upon printing of the photographic images on the sheet.

By the expression “at the origin” is meant, in the description and in the ensuing claims, provision of the perforations either by the manufacturer of the support or by other parties who pre-arrange said support prior to its being made available on the market.

If the holes made at the origin on the sheets were to be normally open, i.e., were through holes as in normal sheets for ringed classifiers or the like, a serious drawback would arise due to the fact that, if the photographic print were to be extended substantially over the entire useful surface of the sheet (a possibility that normally exists with the usual photographic-printing computer programs currently available), the inking pigments would fatally pass through the holes, thus penetrating within the printer and consequently generating smearing and deposits that could even jeopardize proper operation of the printer itself. In order to overcome this drawback, it would be sufficient to limit the printing area excluding the perforated area of the sheet, which, however, would limit considerably the format available with a waste of the area that can be printed, a fact that is evidently disadvantageous also taking into account the far from negligible cost of the support. By way of example, a normal sheet of paper for digital photographic printing in the A4 format (21×29.7 cm) has a total useful surface of 623.7 cm². In order to prevent the drawback referred to above, the print would hence not have to extend beyond a distance of approximately 15 mm from the perforated border of the sheet, thus limiting the printing surface to an area of 19.5×29.7 cm., corresponding to a surface of 579.15 cm² with a loss of approximately 7%.

On the other hand, the procedure of limiting (by modifying the printing settings of the photo-managing program) the printing area with respect to the standards envisaged for each printer would entail interventions that may prove complex and far from convenient particularly for less skilled users, such as precisely those that form the extremely wide range of consumers at which the present invention is aimed (printing in a domestic environment from a digital camera or from a magnetic support by means of a computer interfaced to a non-professional printer).

Closing of the perforations of the supporting sheets according to the invention hence enables said limitations to be overcome, enabling the available printing surface of the sheet to be integrally exploited without any loss of space but at the same time safeguarding the integrity and cleanliness of the printer.

Normally, the printing surface coating of the support for digital photographic prints is set on one face of the sheet: the invention envisages that the perforations, which, as has been said, are provided along at least one border of the sheet, are closed, i.e., sealed on its opposite face. Closing can be conveniently obtained by means of a protective adhesive strip applied in such a way that it can be peeled off on said opposite face; said strip may be continuous and common to all the perforations, or else divided into separate portions, each associated to a respective hole or to a group of respective holes. In either case, purposely designed non-adhesive parts will be provided designed to facilitate detachment thereof from the sheet.

According to a further advantageous characteristic of the invention, the sheet is provided, along the aforesaid at least one perforated border, with a reinforcement film made of plastic material or of other material, which is applied, also this at the origin, at least in a position corresponding to the areas surrounding the aforesaid perforations, the purpose of this being to ensure a high resistance against any risk of tearing of the holes following upon insertion of the sheet into and removal thereof from the ringed file-holder. In this case, the invention envisages that the adhesive strip for closing the perforations will be applied on said reinforcement film. This further facilitates the subsequent detachment of the adhesive strip by the user following upon printing of the photographic image on the sheet.

According to a further aspect of the invention, the perforations of the sheet may be made by means of total dinking, and hence be made already as through holes at the origin, or else they may consist in half-dinked perforations, and in this case they will opened and become through holes following upon removal of the adhesive strip, which will take away with it the half-dinked portions by detaching them from the sheet.

### BRIEF DESCRIPTION OF THE DRAWINGS

Further characteristics and advantages of the invention will emerge clearly in the course of the ensuing detailed description with reference to the annexed plate of drawings, which is provided purely by way of non-limiting example, and in which:

FIG. 1 is a front view of a support for digital photographic printing according to the invention, represented after printing; and

FIG. 2 is a dorsal perspective view at a reduced scale of the sheet.

### DETAILED DESCRIPTION OF THE INVENTION

With reference to the plate of drawings, number 1 designates a sheet support for digital photographic printing according to the invention, typically (but not necessarily) in A4 format.

The sheet 1 consists, in a way generally in itself known, of a substrate, for example made of cellulose or of other material of adequate thickness, the front face of which is coated with a surface patina coating designed to receive inking pigments from a printer (for example, of the ink-jet type, or else laser type, or else dye-sublimation type, or else again other different types that may be developed in future), operatively associated to a computer equipped with a photo-managing program or directly from a digital camera or a memory card with printing function. In the example illustrated, printed on the front face 2 of the sheet 1 is a photographic image, which occupies practically the entire useful surface thereof, except for a thin perimetral margin. Of course, the sheet 1 is able to receive even a number of photographic images of smaller format via selection of the options made available by the computer program.

According to the primary characteristic of the invention, the sheet 1 is formed at the origin, at least in the proximity of the border of one of its larger sides designated by 3, with a plurality of perforations 4 in the form of circular holes typically arranged in a way corresponding to that of the rings of a normal ringed file-holder.

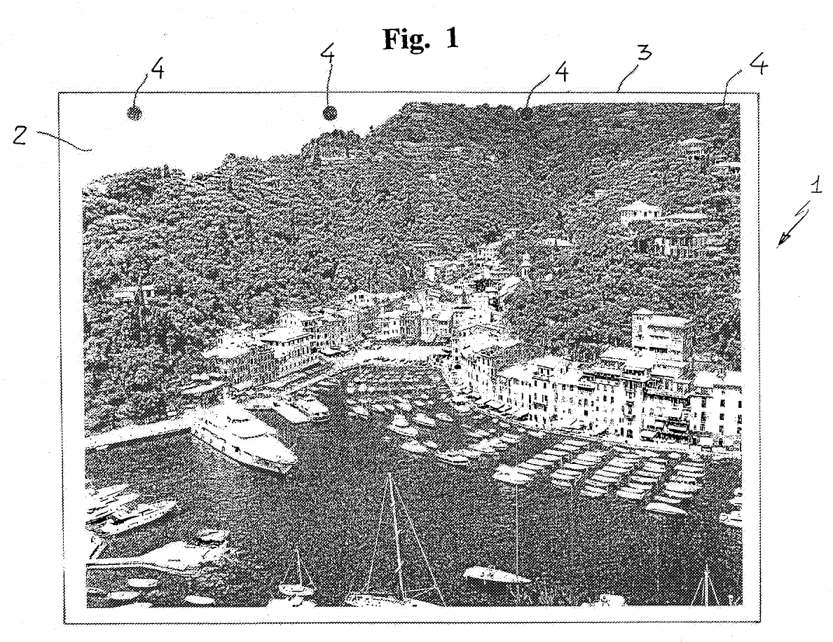

As may be seen in FIG. 1, the holes 4 are arranged in an area designed also (albeit not necessarily) to be included in the photographic image printed on the face 2 of the sheet 1. For this reason, the holes 4 are closed at the origin, i.e., sealed in the way clarified in what follows, in such a way as to be then openable following upon printing of the photographic image on the sheet 1.

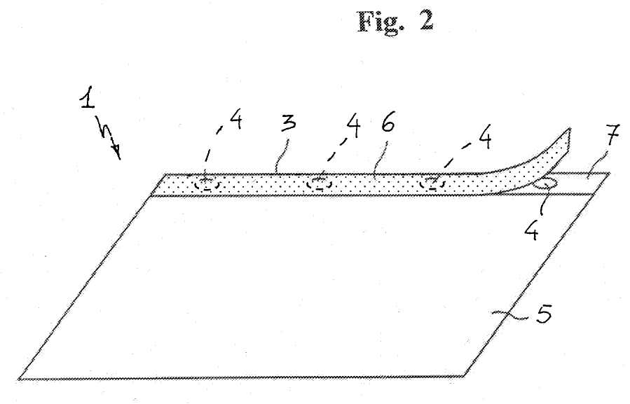

The re-openable closing of the holes 4 is made on the dorsal face of the sheet 1, designated by 5 in FIG. 2. In the case of the example illustrated, a protective adhesive strip 6 is provided, applied in such a way that it can be peeled off along the side 3 of the sheet 1 precisely in such a way as to seal the holes 4.

The protective strip 6, which may be made of any suitable material, such as, for example, paper or plastic material, will have a minimum width at least larger than the diameter of the holes and may have a length identical to that of the side 3 or else smaller so as to terminate at a certain distance from one or both of the smaller opposite sides of the sheet 1. Furthermore, instead of being continuous, the strip 6 may be divided into two or else four distinct and separate portions, obviously applied once again so as to cover the respective holes or sets of holes 4.

The protective strip 6, which has a minimum thickness compatible with its own function, is preferably self-adhesive so as to adhere to the dorsal face 5 of the sheet 1 with a low adhesive capacity in order to enable easy removal thereof. Said removal may be conveniently facilitated by rendering the strip 6 non-adhesive or de-adhesivized in a position corresponding to an area close to one or each of its ends, or else along one or both of its longitudinal edges, so as to facilitate gripping thereof by the user when it is to be detached.

The protective strip 6 may be transparent or, more preferably, coloured so as to facilitate identification thereof at the moment of its detachment.

The holes 4 can be totally dinked and hence be rendered through holes at the moment of fabrication or of a subsequent step of processing of the sheet 1, or else they may simply be half-dinked so as not to interrupt the useful printing surface of the front face 2 of the sheet 1. In this case the holes 4 will be opened, after printing of the photographic image, as a result of removal of the half-dinked portions following upon the pulling action exerted by the protective strip 6 at the moment of its detachment from the dorsal face 5.

According to another aspect of the invention, the sheet 1 can be provided, along the side 3 presenting the perforations 4, with a reinforcement film made of plastic material, paper or other material, designated by 7 in FIG. 2, which is also applied at the origin on the dorsal face 5 at least in a position corresponding to the areas surrounding said holes 4. The function of the film 7, the characteristics of which may correspond to the ones described in the Italian patent No. IT-B-1306819 with reference to simple sheets of paper for blocks of note paper and the like, is that of effectively preventing tearing in the areas of the holes 4 at the moment when these are introduced into and removed from the ringed file-holder.

With this arrangement, which is, however, optional since the reinforcement film 7 could even be omitted, the removal of the protective strip 6 is further facilitated in the case where it is applied, as in the example illustrated, on top of the reinforcement film 7. In this case, in fact, the protective strip 6, instead of adhering to the cellulose substrate of the sheet 1, adheres to the thermoplastic material of the reinforcement film 7, and hence in a way that may enable it to be peeled off more easily.

The sheet 1 thus made may be introduced into a normal printer as any other sheet of paper for digital photographic printing and then printed. During printing the ink will not penetrate through the holes 4 in so far as they are totally sealed by the protective strip 6, and the ink possibly deposited in the area of said holes 4 will be absorbed either by the half-dinked but non-removed portions of the sheet 1 or else by the adhesive surface of the strip 6 itself.

Following upon printing of the sheet 2 and removal thereof from the printer, the protective strip 6 will be raised in a position corresponding to a non-adhesive or de-adhesivized area thereof, and may be easily detached from the dorsal face 5 of the sheet 1, i.e., from the reinforcement film 7. With this operation, the holes 4 are freed and opened, rendering them usable for filing the sheet 1 in a normal ringed file-holder or the like.

Of course, the effects of the present invention extend to the models that achieve equal utility using the same innovative idea.

1. A sheet support for digital photographic prints, comprising:
a substrate having a printing surface coating set on a face of the sheet and designed to receive inking pigments from a printer operatively associated to a photo-managing program;
said substrate comprising at least one border and perforations along said at least one border made at the origin for insertion of the sheet in a ringed file-holder, said perforations being normally closed on the face of the sheet opposite to said face having said printing surface coating and being openable following upon printing of the photographic image on the sheet.

2. The support according to claim 1, wherein each of said perforations is closed by a protective adhesive strip that is applied in such a way that said strip can be peeled off said opposite face of the sheet.

3. The support according to claim 2, wherein said protective strip is continuous and common to all the perforations.

4. The support according to claim 3, wherein said protective strip has a length substantially equal to or slightly smaller than the length of said at least one side of the sheet and a width at least equal to the extent of said perforations.

5. The support according to claim 4, wherein said protective strip is divided into distinct portions, each of said portions associated to a respective perforation or to a respective group of perforations.

6. The support according to claim 2, wherein said protective strip has at least one non-adhesive or de-adhesivized gripping portion.

7. The support according to claim 1, further comprising along said at least one border a reinforcement film applied at the origin at least in a position corresponding to the areas surrounding said perforations, and in that said protective strip is applied on said reinforcement film.

8. The support according to claim 2, wherein said protective strip is colored.

9. The support according to claim 1, wherein said perforations are made as through holes at the origin.

10. The support according to claim 1, wherein said perforations are made at the origin by means of half-dinking and are obtained as through holes following upon removal of said protective strip.

11. The support according to claim 3, wherein said protective strip has at least one non-adhesive or de-adhesivized gripping portion.

12. The support according to claim 4, wherein said protective strip has at least one non-adhesive or de-adhesivized gripping portion.

13. The support according to claim 5, wherein said protective strip has at least one non-adhesive or de-adhesivized gripping portion.

14. The support according to claim 2, further comprising along said at least one border a reinforcement film applied at the origin at least in a position corresponding to the areas surrounding said perforations, and in that said protective strip is applied on said reinforcement film.

15. The support according to claim 3, further comprising along said at least one border a reinforcement film applied at the origin at least in a position corresponding to the areas surrounding said perforations, and in that said protective strip is applied on said reinforcement film.

16. The support according to claim 4, further comprising along said at least one border a reinforcement film applied at the origin at least in a position corresponding to the areas surrounding said perforations, and in that said protective strip is applied on said reinforcement film.

17. The support according to claim 5, further comprising along said at least one border a reinforcement film applied at the origin at least in a position corresponding to the areas surrounding said perforations, and in that said protective strip is applied on said reinforcement film.

18. The support according to claim 6, further comprising along said at least one border a reinforcement film applied at the origin at least in a position corresponding to the areas surrounding said perforations, and in that said protective strip is applied on said reinforcement film.

19. The support according to claim 3, wherein said protective strip is coloured.

20. The support according to claim 4, wherein said protective strip is coloured.
